(19) United States
(12) Patent Application Publication
(10) Pub. No.: US 2018/0029200 A1
(43) Pub. Date: Feb. 1, 2018

(54) Supporting Suction Assembly, Supporting Device and its Operation Method

(71) Applicants: BOE Technology Group Co., Ltd., Beijing (CN); HEFEI Xinsheng Optoelectronics Technology Co., Ltd, Heifei City (CN)

(72) Inventors: Shancai Zhang, Beijing (CN); Dayu Zhang, Beijing (CN)

(73) Assignees: BOE Technology Group Co., Ltd., Beijing (CN); HEFEI Xinsheng Optoelectronics Technology Co., Ltd., Hefei City (CN)

(21) Appl. No.: 15/126,918

(22) PCT Filed: Dec. 18, 2015
(86) PCT No.: PCT/CN2015/097803

§ 371 Date: Sep. 16, 2016

(30) Foreign Application Priority Data
Aug. 3, 2015 (CN) 201510481948.8

(51) Int. Cl. B25B 11/00

(52) U.S. Cl. CPC B25B 11/005

(57) ABSTRACT

A supporting suction assembly, a supporting device and its operation method are provided. The supporting suction assembly including: an extension part extendable along an up-and-down direction; a rotation part mounted on a top portion of the extension part, wherein the rotation part includes a rotation ball joint and a suction cup fixedly mounted on the rotation ball joint, the rotation ball joint is provided with a first venting hole communicating with outside, and the suction cup can be rotated along with the rotation ball joint; and an extraction passage provided in the extension part to be communicated with the first venting hole. Since the supporting suction assembly can be ascended and descended individually, a workpiece having a surface with irregular shape, including a curved surface substrate, etc., can be suctioned.

### TECHNICAL FIELD

The present disclosure relates to a jig in a display field, and in particularly, to a supporting suction assembly, a supporting device including the supporting suction assembly and an operation method of the supporting device.

### BACKGROUND

Curved surface glass panels are widely applied, can be applied in manufacturing a curved surface touch screen for example, and can also be applied in manufacturing a curved surface display apparatus, such as a curved surface television, a curved surface mobile phone, a curved surface tablet, and so on. Since the distances between a conventional flat display apparatus and eyeballs of a viewer are uneven, display effect at edges is not ideal, and vision fatigue is easily occurred. For a curved surface display apparatus, since a display screen and the eyeballs of the viewer are spaced equally, there is no loss in picture quality at edges, causing comfortably watching experience and excellent effect.

In the Chinese Patent Application No. 200810108919.7, a substrate suction device is disclosed, however, the substrate suction device is used to suction and hold a flat panel glass substrate. However, as the market share of curved surface display apparatus is gradually increased and the size thereof is gradually enlarged, the curved surface display apparatus has become a main trend of the development of display apparatus. Therefore, there is a need for a supporting device suitable for fixing a workpiece having a profiled or irregular shape, such as a curved surface substrate, or the like.

### SUMMARY

A first aspect of the present disclosure provides a supporting suction assembly including: an extension part extendable along an up-and-down direction; a rotation part mounted on a top portion of the extension part, wherein the rotation part includes a rotation ball joint and a suction cup fixedly mounted on the rotation ball joint, the rotation ball joint is provided with a first venting hole communicating with outside, and the suction cup can be rotated along with the rotation ball joint; and an extraction passage provided in the extension part and communicated with the first venting hole.

A second aspect of the present disclosure provides a supporting device including: a carrying stage; and a plurality of the above described supporting suction assemblies, the plurality of supporting suction assemblies being provided on the carrying stage in an array manner; a height of each of the supporting suction assemblies is adjustable and a supporting face is constructed by the suction faces of the plurality of suction cups as a whole.

A third aspect of the present disclosure provides an operation method for the above described supporting device, including: adjusting heights of the plurality of supporting suction assemblies so that the supporting face is in contact with a surface of a workpiece; and enabling the plurality of supporting suction assemblies to perform vacuum adhesion to adhere and hold the surface of the workpiece by the suction cups.

### DESCRIPTION OF THE ATTACHED DRAWINGS

In order to more clearly describe the technical solution of the embodiments of the present disclosure, the attached drawings for the embodiments will be briefly described, it is obvious that the attached drawings in the following description only illustrate some embodiments of the present disclosure, but not are intended to limit the present disclosure.

FIG. 1 is a side view schematically showing a supporting device according to an embodiment of the present disclosure;

FIG. 2 is a top view schematically showing a plurality of supporting suction assemblies according to an embodiment of the present disclosure;

FIG. 3 is a sectional view schematically showing a supporting suction assembly according to an embodiment of the present disclosure;

FIG. 4(a) and (b) are sectional views schematically showing two kinds of suction cups according to an embodiment of the present disclosure, respectively;

FIG. 5 is a sectional view schematically showing an extraction passage having flared shape according to an embodiment of the present disclosure;

FIG. 6 schematically shows an extraction path of the supporting device according to an embodiment of the present disclosure; and

FIG. 7 schematically shows a protection cover of the supporting device according to an embodiment of the present disclosure.

### DETAILED DESCRIPTION

In order to make objects, technical details and advantages of the embodiments of the disclosure apparent, the technical solutions of the embodiments will be described in a clearly and fully understandable way in connection with the drawings related to the embodiments of the disclosure. Apparently, the described embodiments are just a part but not all of the embodiments of the disclosure. Based on the described embodiments herein, those skilled in the art can obtain other embodiment(s), without any inventive work, which should be within the scope of the disclosure.

Unless otherwise defined, all the technical and scientific terms used herein have the same meanings as commonly understood by one of ordinary skill in the art to which the present disclosure belongs. The terms “first,” “second,” etc., which are used in the description and the claims of the present application for disclosure, are not intended to indicate any sequence, amount or importance, but distinguish various components. Also, the terms such as “a,” “an,” etc., are not intended to limit the amount, but indicate the existence of at least one. The terms “comprise,” “comprising,” “include,” “including,” etc., are intended to specify that the elements or the objects stated before these terms encompass the elements or the objects and equivalents thereof listed after these terms, but do not preclude the other elements or objects. The phrases “connect”, “connected”, etc., are not intended to define a physical connection or mechanical connection, but may include an electrical connection, directly or indirectly. “On,” “under,” “right,” “left” and the like are only used to indicate relative position relationship, and when the position of the object which is described is changed, the relative position relationship may be changed accordingly.

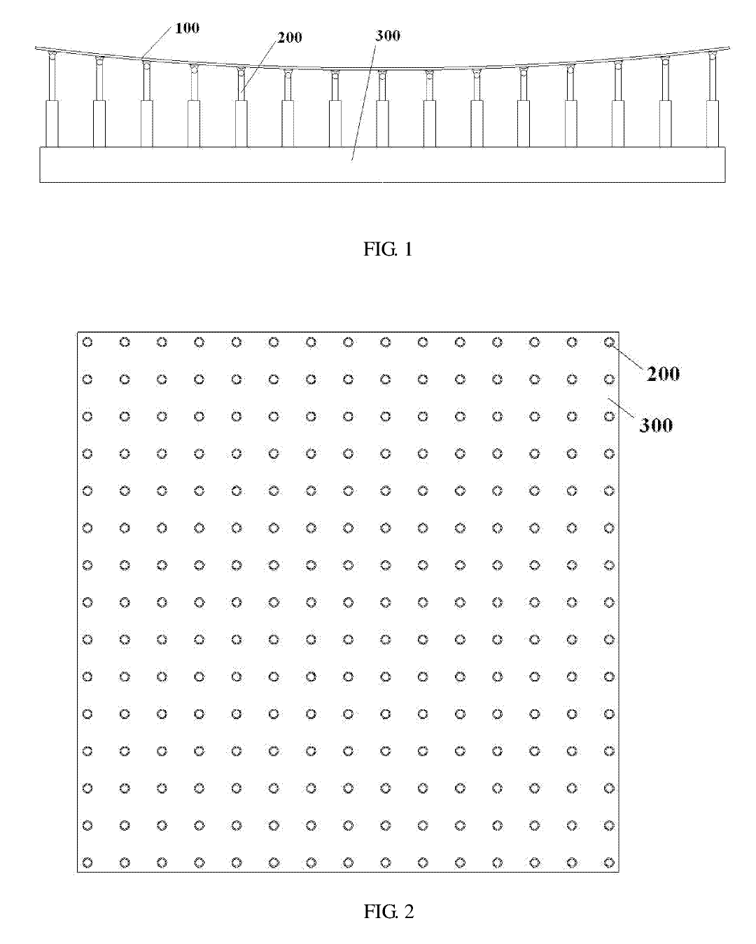

As shown in FIG. 1 and FIG. 2, a supporting device according to an embodiment of the present disclosure includes a carrying stage 300 and a plurality of supporting suction assemblies 200 provided on the carrying stage 300 in an array manner; each of the supporting suction assemblies 200 has an adjustable height so that function of sucking and holding can be achieved according to the shape of the surface of a workpiece to be supported. As shown in FIG. 1, tops of the plurality of supporting suction assemblies 200 form a supporting face as a whole. For example, the supporting face can be adjusted into a curved surface so as to achieve the supporting of a curved surface substrate 100. Of course, the supporting face can also be a planar surface.

Hereinafter, the curved surface substrate will be described as an example of the workpiece to be supported, however, the above supporting device can be applied to suction any workpiece having a regular or irregular shaped surface, for example, the surface of the workpiece can be a planar surface or a non-planar surface, such as a curved surface, a sphere surface, or the like.

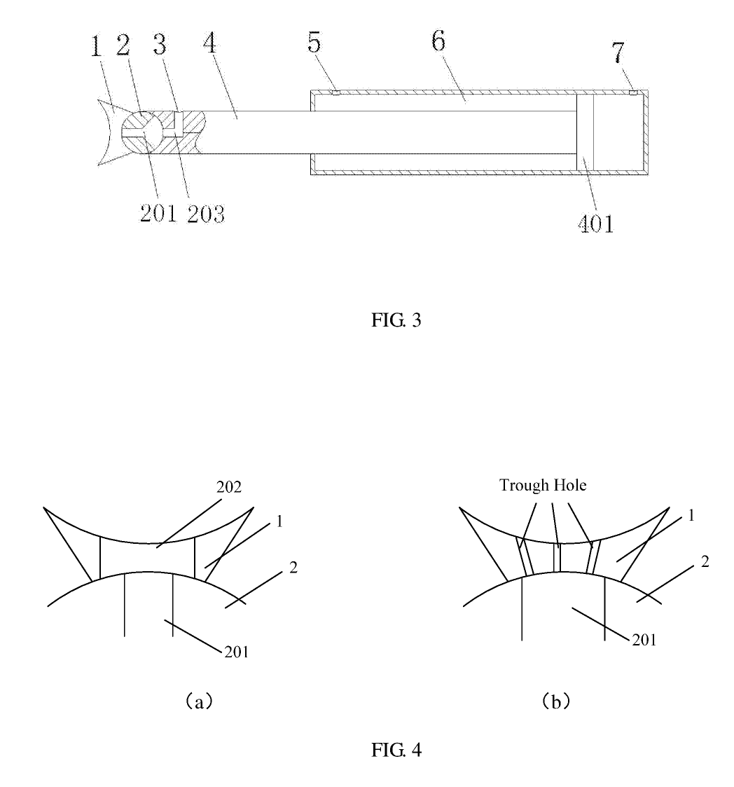

FIG. 3 schematically shows a partial enlarged view of the supporting suction assembly 200. The supporting suction assembly 200 includes an extension part which is extendable in an up-and-down direction and a rotation part mounted on a top of the extension part; the rotation part includes a rotation ball joint 2 and a suction cup 1 fixedly mounted on the rotation ball joint 2, the rotation ball 2 has a first venting hole 201 communicated with outside, and the suction cup 1 is rotated along with the rotation ball joint 2. The supporting suction assembly 200 further includes an extraction passage 203 that is provided in the extension part and to be communicated with the first venting hole 201, the extraction passage 203 has an end communicated with the first venting hole 201 and another end connected with an external air extraction device. In the embodiment of the present disclosure, the external air extraction device may employ a vacuum pump or the like. When air extraction is needed, the vacuum pump is started, and when inflating is needed, a valve on an extraction path can be communicated directly with outside, so that air can be introduced into pipes. Other inert gas can also be used as the gas source for inflating.

The suction cup 1 is made from a flexible material, such as engineering plastic, to avoid damaging to the workpiece, and has good abrasive resistance. The suction cup 1 has a curved suction face, and the above mentioned supporting face can be constructed by a plurality of the suction faces of the plurality of suction cups 1 for supporting and suctioning the surface of the cured surface substrate 100. The suction cup 1 includes a second venting hole 202 communicated with the first venting hole 201 in the rotation ball joint 2, and the second venting hole 202 has an opening provided at a suction face of the suction cup 1 and is communicated with outside. When the supporting suction assembly 200 is used to suction, air between the suction face and the surface of the workpiece is extracted away through the first venting hole 201, the second venting hole 202 and the extraction passage 203, so that a negative pressure state is produced between the suction face and the surface of the workpiece, and thus firmly suction between the suction cup 1 and the workpiece can be achieved.

FIG. 4a and FIG. 4b schematically show two implementation manners of the second venting hole in the suction cup. For example, the second venting hole 202 may include one through-hole located at a center thereof, as shown in FIG. 4a. In some implementations, the through-hole has a diameter larger than the diameter of the first venting hole 201 on a contact surface between the rotation ball joint 2 and the suction cup 1, so as to facilitate to extract the air above the suction face quickly. Still for example, the second venting hole 202 may include a plurality of through holes distributed in the suction cup, as shown in FIG. 4b, and accordingly, a plurality of suction openings are formed in the suction face, so that the air between the suction cup 1 and the workpiece can be simultaneously and quickly extracted away. The diameter of the first venting hole 201 in the rotation ball joint 2 can be determined according to arrangement of the second venting hole. The arrangement of the second venting hole 202 is not limited to the above two implementations.

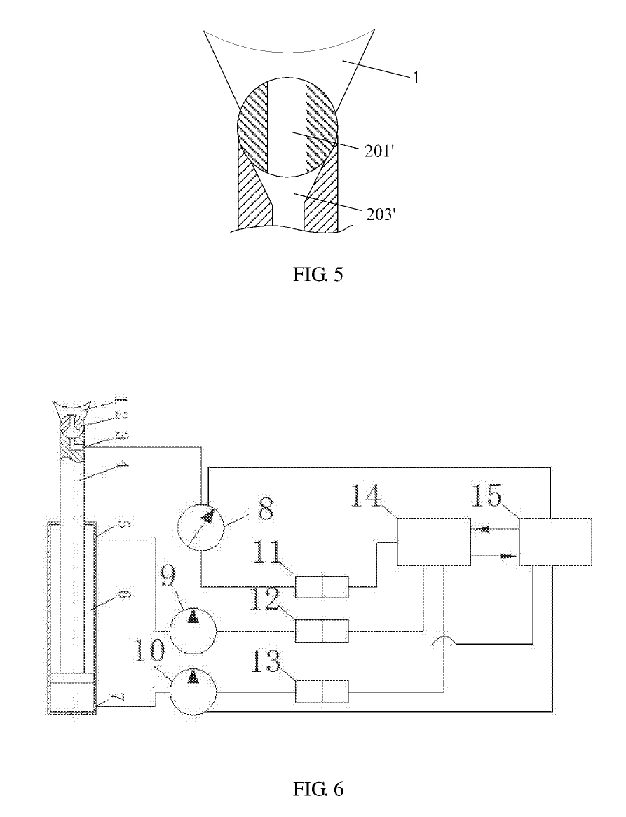

In at least one embodiment of the present disclosure, at an interface where the rotation ball joint 2 is connected with the extension part, one of the first venting hole and the extraction passage has a flared shape having a width gradually increased as it approaches to the interface, so that the suction function can be maintained even when the rotation ball joint 2 is relatively rotated. For example, as shown in FIG. 3, at the interface where the rotation ball joint 2 is connected with the extension part, the first venting hole has a flared shape (or referred to as a taper shape) having a width gradually increased as it approaches to the interface. If it is desired that the rotation ball joint 2 has a larger rotatable angle, the width of the flared shape should be provided so as to be relatively large, so that the area of the flared shape is larger than the area of the extraction passage 203. In this way, even when the rotation ball joint 2 is rotated by a large angle, the communication between the extraction passage 203 and the first venting hole 201 can also be maintained. In another example, an opening of the extraction passage 203′ can also be provided so as to be of a flared shape, as shown in FIG. 5, the above object can equally be achieved. At this time, there is no special limitation on the shape of the first venting hole 201′, and the first venting hole may include through holes having a constant size, or may has through holes in flared shape or other shape, as long as the extraction passage 203′ can be communicated with the first venting hole 201′.

Returning to FIG. 3, the extension part may include a piston rod 4 and an air cylinder 6 (or can also be an oil cylinder) sheathed around the piston rod 4, the piston rod 4 can be driven in the air cylinder 6 to be reciprocated linearly. The rotation ball joint 2 is rotatably and hermetically connected to a top portion of the piston bar 4. Since the up and down movement of the piston rod 4 brings the rotation ball joint 2 at its top portion as well as the suction cup 1 into the up and down movement so that the height of the supporting suction assembly 200 can be adjusted, suction can be performed with better adhesion with the surface of the workpiece. The piston bar 4 includes a plunger 401 tightly fitted with an inner wall of the air cylinder, when the piston rod 4 is vertically placed, as shown in FIG. 1, the air cylinder 6 is divided into two portions, i.e., an upper portion and a lower portion, by the plunger 401. A first hole 7 is provided on an outer wall of the lower portion of the air cylinder to import air into or extract air from the lower space of the air cylinder. When the piston rod 4 is needed to be ascended, air is inflated into the space below the plunger 401 through the first hole 7, and when the piston rod 4 is needed to be descended, air is extracted outside through the first hole 7, and at the same time, the piston rod 4 is descended by its own gravity. In another example, a second hole 5 is also provided on an outer wall of the upper portion of the air cylinder 6, to input air into or extract air from the upper space of the air cylinder 6. By providing the second hole 5, differentially driving of the piston rod 4 can be achieved, that is, when the piston rod 4 is needed to be ascended, pressure in the lower space is increased by inflating through the first hole 7, and at the same time pressure in the upper space is decreased by extracting air through the second hole 5, and when the piston rod 4 is needed to be descended, the pressure in the lower space is decreased by extracting air though the first hole 7 and at the same time the pressure in the upper space is increased by inflating through the second hole 5. Compared with unidirectional driving, the height of the piston rod 4 can be more quickly adjusted by this differential driving manner.

In at least one embodiment of the present disclosure, the plurality of supporting suction assemblies 200 are arranged into an m×n array, where m is larger than or equal to 2, and n is larger than or equal to 2. An interval between two adjacent rows can be equal to an interval between two adjacent columns, or can also be unequal. For example, as shown in FIG. 2, 225 supporting suction assemblies 200 are arranged into a 15×15 array, and the interval between two adjacent row is equal to the interval between two adjacent columns. It can be understood that the number, row pitch, column pitch, and arrangement of the supporting suction assemblies 200 can be determined according to the size of the surface of the workpiece to be supported. For example, when a curved surface substrate is used, it is suitable to provide relatively more suction assemblies there below, so that areas of the panel surface having different heights can be supported, and stress can be avoided from incurring. The row pitch and column pitch can be determined depending on the curvature and size of the curved surface substrate, the more the pitch and the curvature are, the denser and the smaller the pitches are, whereby flexing and deformation of the glass panel due to its own weight can be avoided.

FIG. 6 schematically shows a block view of an extraction path in the supporting device according to an embodiment of the present disclosure. The extraction path is formed for each of the supporting suction assemblies 200, and here a controller and an air extraction device 14 can be a common device. As shown in FIG. 6, the suction cup 1 is connected with the air extraction device 14 such as a vacuum pump through a pressure sensor 8 and a valve 11. The second hole 5 is connected with the air extraction device 14 through a pressure sensor 9 and a valve 12. The first hole 7 is connected with the air extraction device 14 through a pressure sensor 10 and a valve 13. The pressure sensors 8, 9, and 10 function to detect pressure in the extraction path, and the pressure signals are transmitted to the controller 15 by output signal lines. Signals output from the controller 15 are input into the valves 11, 12, 13 and the air extraction device 14. The controller 15 is operatively used to control an extension amount of the extension part in the up-and-down direction, to adjust the shape of the supporting face.

Hereinafter, the operation process of the supporting device of FIG. 6 will be described in detail. When the device is put into operation, the air extraction device 14, the valve 11, the valve 12, and the valve 13 are activated, so as to supply air to the first hole 7 to ascend the piston rod 4, and extract air through the third hole 3. When the suction cup 1 is adhered with the curved surface substrate 100, the pressure detected by the pressure sensor 8 reaches a certain threshold, at this time, the suction cup 1 tightly suctions the curved surface substrate, the valve 12 is closed so as to stop the ascend of the piston rod 4. When it is need to release the curved surface substrate 100, the height of the piston rod 4 is kept unchanged, the direction of the air flow is changed so that the third hole 3 becomes an air inlet, and the suction cup 1 is released. In the case that the suction cup 1 has not contacted with the curved surface substrate (for example, the suction cup 1 has been moved to a position beyond the surface of the substrate), when the pressure detected by the pressure sensor 10 reaches a threshold (means that the piston rod 4 has been at its top limit point), the valves 11, 12 and 13 are closed and the air extraction device 14 is stopped extracting air, so as to save energy. During the piston rod 4 is ascended, the second hole 5 is an air outlet and the first hole 7 is an air inlet; whereas, during the piston rod 4 is descended, the second hole 5 is the air inlet and the first hole 7 is the air outlet. When the curved surface substrate is tightly fixed, the third hole 3 is the air outlet. When the curved surface substrate is released, the third hole 3 is the air inlet.

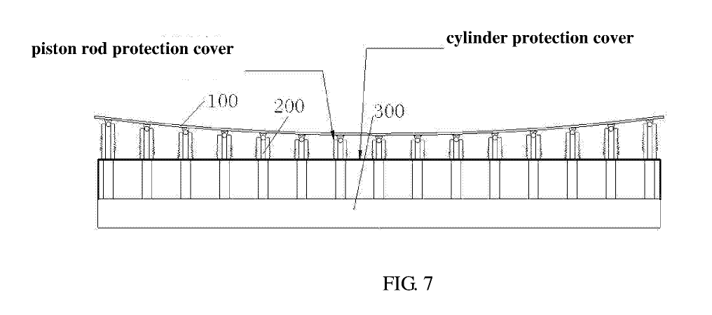

In order to protect the supporting suction assemblies, as shown in FIG. 7, a cylinder protection cover can be provided at outside of all the air cylinders, and a piston rod protection cover can be provided at outside of each of the piston rods. When being not used, the supporting suction assemblies can be retracted into the protection cover so as to prevent moisture or dust from permeating.

According to another embodiment of the present disclosure, a operation method for the supporting device according to any one of the above embodiments is provided, including: adjusting the height of the plurality of supporting suction assemblies so that the supporting face constructed by the plurality of suction faces is in contact with the surface of the workpiece; and enabling the plurality of supporting suction assemblies to vacuum suction to suction and hold the surface of the workpiece to be supported by ways of the suction cups.

For example, the workpiece to be supported, such as a curved surface substrate 100, is carried to the top of the carrying stage 300 by using a carrying device such as a robotic arm or the like, then, the valve 13 is opened (the valve 12 can also be opened), under control of the controller 15, the lower space of the air cylinder 6 is inflated (the upper space of the air cylinder 6 can be extracted at the same time), until the suction cup 1 at the top of the piston rod 4 is moved to be in contact with the surface of the curved surface substrate 100. Then, the valve 11 is opened, and under control of the controller 15, the air extraction device 14 extracted the air outside from the extraction passage 203. At this time, since the space between the suction cup 1 and the surface of the workpiece is in a negative pressure state, the surface of the curved surface substrate 100 is adhered and held by the suction cup 1. Since the surface of the curved surface substrate 100 has a certain curvature, during suctioning, the rotation ball joint 2 is naturally rotated to a certain angle following the extraction process, so that the suction face of the suction cup 1 is adhered with the curved surface.

Still for example, the heights of the plurality of supporting suction assemblies can be controlled according to the shape of the surface of the workpiece to be supported in advance, so that the supporting face conforms with the surface of the workpiece to be supported, and then the workpiece to be supported is placed on the supporting face. This adjusting process is similar to the above example, and will not be further described.

In the supporting device according to the above embodiments of the present disclosure, each of the supporting suction assemblies can be controlled individually, so as to be ascended or descended individually, therefore, it is capable of suctioning the workpiece having a surface of a irregular shape, such as a curved surface substrate, or the like, and is especially suitable for the curved surface substrates with different sizes and different curvatures. Since the number of the supporting suction assemblies is large, multipoint supporting can be achieved, the suction becomes more stable, to facilitate the subsequent process, e.g., coating, exposure, bonding, and so on, to be performed on the workpiece. In addition, since the suction cup is made of a flexible material, has nearly no damage incurred to the surface of the workpiece, and can improve the productivity of the workpieces in each of the processes. The operation method for the supporting device can be performed manually, and also can be performed by a set of predetermined program.

What are described above is related to the illustrative embodiments of the disclosure only and not limitative to the scope of the disclosure; the scopes of the disclosure are defined by the accompanying claims.

The application claims priority to the Chinese patent application No. 201510481948.8, filed on Aug. 3, 2015, the entire disclosure of which is incorporated herein by reference as part of the present application.

1. A supporting suction assembly including:
an extension part extendable along an up-and-down direction;
a rotation part mounted on a top portion of the extension part, wherein the rotation part includes a rotation ball joint and a suction cup fixedly mounted on the rotation ball joint, the rotation ball joint is provided with a first venting hole communicating with outside, and the suction cup can be rotated along with the rotation ball joint; and
an extraction passage provided in the extension part and communicated with the first venting hole.

2. The supporting suction assembly according to claim 1, wherein the extraction passage has an end communicated with the first venting hole and another end connected with an external air extraction device.

3. The supporting suction assembly according to claim 1, wherein the suction cup includes a second venting hold communicated with the first venting hole in the rotation ball joint, and the second venting hole has an opening provided on a suction face of the suction cup and communicated with the outside.

4. The supporting suction assembly according to claim 1, wherein at an interface where the rotation ball joint is connected with the extension part, one of the first venting hole and the extraction passage has a flared shape, a width of which is gradually increased as it approaches to the interface.

5. The supporting suction assembly according to claim 1, wherein the extension part includes a piston rod and an air cylinder or an oil cylinder sheathed around the piston rod, and the piston rod is driven to be reciprocated linearly in the air cylinder or the oil cylinder.

6. The supporting suction assembly according to claim 5, wherein the piston rod includes a plunger tightly fitted with an inner wall of the air cylinder or the oil cylinder, the air cylinder or the oil cylinder is divided by the plunger into two portions, i.e., an upper portion and a lower portion,
a first hole is provided at an outer wall of the lower portion of the air cylinder for inputting air or oil into a lower space of the air cylinder or the oil cylinder or extracting the air or the oil from the lower space.

7. The supporting suction assembly according to claim 6, wherein the air cylinder or the oil cylinder is provided with a second hole on an outer wall of the upper portion for inputting air or oil into an upper space of the air cylinder or the oil cylinder or extracting the air or the oil from the upper space.

8. The supporting suction assembly according to claim 1, wherein rotatable hematic connection is formed between the rotation ball joint and a top portion of the piston rod.

9. A supporting device including:
a carrying stage; and
a plurality of supporting suction assemblies claim 1,
the plurality of supporting suction assemblies being provided on the carrying stage in an array manner;
wherein a height of each of the supporting suction assemblies is adjustable and a supporting face is constructed by suction faces of the plurality of suction cups as a whole.

10. The supporting device according to claim 9, wherein the plurality of supporting suction assemblies are arranged into an m×n array, where m is larger than or equal to 2 and n is larger than or equal to 2.

11. The supporting device according to claim 10, wherein an interval between two adjacent rows is equal to an interval between two adjacent columns.

12. The supporting device according to claim 9, further including a controller operatively controlling an extension amount of each extension part in the up-and-down direction, to adjust a shape of the supporting face.

13. The supporting device according to claim 9, further including:
an extraction path connected with the extraction passage; and
an air extraction device connected with the extraction path to perform vacuum suction.

14. The supporting device according to claim 13, further including a pressure sensor provided in the extraction path,
wherein the pressure sensor is used to detect air pressure in the extraction path.

15. The supporting device according to claim 9, wherein the supporting face is a non-planar surface.

16. An operation method for the supporting device according to claim 9, including:
adjusting heights of the plurality of supporting suction assemblies so that the supporting face is in contact with a surface of a workpiece; and
enabling the plurality of supporting suction assemblies to perform vacuum adhesion to suction and hold the surface of the workpiece by the suction cups.

17. The operation method according to claim 16, wherein adjusting the heights of the plurality of supporting suction assemblies so that the supporting face is in contact with the surface of a workpiece includes:
controlling the heights of the plurality of supporting suction assemblies according to a shape of the surface of the workpiece so that the supporting face conforms with the surface of the workpiece, and then placing the workpiece on the supporting face.
